(19) United States
(12) Patent Application Publication
(10) Pub. No.: US 2021/0160577 A1
(43) Pub. Date: May 27, 2021

(54) METHOD FOR PLAYING VIDEO, ELECTRONIC DEVICE AND STORAGE MEDIUM

(71) Applicant: Wangsu Science & Technology Co., Ltd., Shanghai (CN)

(72) Inventor: Yanpeng CHEN, Shanghai (CN)

(21) Appl. No.: 17/169,345

(22) Filed: Feb. 5, 2021

Related U.S. Application Data
(63) Continuation of application No. PCT/CN2020/114082, filed on Sep. 8, 2020.

(30) Foreign Application Priority Data
Jul. 25, 2019 (CN) 201910676150.7
Feb. 12, 2020 (CN) PCT/CN2020/074964
Jul. 13, 2020 (CN) 202010667864.4

(51) Int. Cl. H04N 21/472; H04N 21/482; H04N 21/845

(52) U.S. Cl. CPC H04N 21/47202; H04N 21/8456; H04N 21/4825

(57) ABSTRACT

The present disclosure discloses a method for playing a video, an electronic device and a storage medium, and relates to video playing technologies. The video playing method includes: acquiring video clip information of a video to be played, where the video to be played includes a plurality of video clips; determining a tree relationship of the video to be played and a first video clip list corresponding to the tree relationship according to the video clip information; and playing the video to be played based on the tree relationship, the first video clip list and a video clip selected by a user.

### CROSS REFERENCE TO RELATED APPLICATIONS

The present application is a continuation of PCT Patent Application No. PCT/CN2020/114082, entitled “METHOD FOR PLAYING VIDEO, ELECTRONIC DEVICE AND STORAGE MEDIUM” filed Sep. 8, 2020, which claims priorities to Chinese Patent Application No. 202010667864.4, entitled “METHOD FOR PLAYING VIDEO, ELECTRONIC DEVICE AND STORAGE MEDIUM,” filed Jul. 13, 2020, PCT Patent Application No. PCT/CN2020/074964, entitled “METHOD AND DEVICE FOR PLAYING INTERACTIVE AUDIO-VIDEO,” filed Feb. 12, 2020, and Chinese Patent Application No. 201910676150.7, entitled “METHOD AND DEVICE FOR PLAYING INTERACTIVE AUDIO-VIDEO,” filed Jul. 25, 2019, each of which is incorporated by reference herein in its entirety.

### TECHNICAL FIELD

The present disclosure relates to video playing technologies, in particular to a method and a device for playing an interactive audio-video.

### BACKGROUND

With rapid development of mobile Internet and continuous improvement of the performance of a terminal device, a user may use a mobile terminal to watch a live broadcast and a video on demand online anytime and anywhere. Due to the real-time nature of the live broadcast, the user may also interact with the video content when watching the live broadcast.

In a conventional play mode of video on demand, the user is a single receiver. When the mobile terminal plays an audio-video on demand, steps such as reading, decoding, audio-video rendering and audio-video synchronization may only be performed from beginning to end on a single media stream or file, and do not support on-demand play in an interactive mode. Thus, the user cannot participate in interactions related to the video content, resulting in lower interest.

### SUMMARY

The present disclosure provides a method and a device for playing an interactive audio-video, which provide a user with experience of video on demand in an interactive mode, and allow the user to interact with a video content to select a video clip for playing, thereby enhancing the user's interest in video on demand.

The present disclosure provides a method for playing a video, including: acquiring video clip information of a video to be played, where the video to be played includes a plurality of video clips; determining a tree relationship of the video to be played and a first video clip list corresponding to the tree relationship according to the video clip information; and playing the video to be played based on the tree relationship, the first video clip list, and a video clip selected by a user.

The present disclosure further provides an electronic device, including: at least one processor; and a memory communicatively coupled to the at least one processor. Herein, the memory stores an instruction executable by the at least one processor, and the instruction is executed by the at least one processor to cause the at least one processor to perform the method for playing the video as described above.

The present disclosure further provides a non-transitory computer readable storage medium including a computer readable instruction which, when read and executed by a computer, causes the computer perform the method for playing the video as described above.

Compared with existing technologies, the present disclosure provides a manner of video on demand in an interactive preview play mode. During playing an on-demand video requested by a user, video clip information of the video to be played which includes a plurality of video clips is acquired first. Then, a tree relationship of the video to be played in an interactive preview play mode and a first video clip list corresponding to the tree relationship are determined according to the video clip information. Subsequently, a video clip of the video to be played that corresponds to a node contained in the tree relationship may be played based on a video clip selected by the user during interacting with an electronic device and the first video clip list. In this way, VOD experience in an interactive mode is provided to the user, so that the user may select and play the video clip through the interaction with video content, thereby improving user's interest in VOD.

In one embodiment, the tree relationship of the video to be played includes a plurality of nodes, each node corresponding to a video clip, the plurality of nodes including a current node and one or more child nodes of the current node, and playing the video to be played based on the tree relationship, the first video clip list, and the video clip selected by the user includes: displaying an option corresponding to each of the one or more child nodes of the current node after playing of a video clip corresponding to the current node in the tree relationship is completed; and acquiring, according to a target child node corresponding to the option selected by the user, a video clip corresponding to the target child node from the first video clip list, and playing the video clip corresponding to the target child node.

In one embodiment, the video clip corresponding to each of the one or more child nodes of the current node is acquired from the first video clip list and preloaded into a first play queue when playing the video clip corresponding to the current node in the tree relationship; and acquiring, according to the target child node corresponding to the option selected by the user, the video clip corresponding to the target child node from the first video clip list, and playing the video clip corresponding to the target child node includes: acquiring, according to the target child node corresponding to the option selected by the user, the video clip corresponding to the target child node from the first play queue after preloaded, and playing the video clip corresponding to the child node.

In one embodiment, after the playing of the video clip corresponding to the current node in the tree relationship is completed, the method further includes: determining whether a video clip corresponding to a node subordinating to the current node includes the video clip corresponding to the current node; responsive to determining that the video clip corresponding to the node subordinating to the current node includes the video clip corresponding to the current node, retaining the video clip corresponding to the current node in the first play queue; and responsive to determining that the video clip corresponding to the node subordinating to the current node does not include the video clip corresponding to the current node, deleting the video clip corresponding to the current node from the first play queue.

In one embodiment, acquiring the video clip corresponding to each of the one or more child nodes of the current node from the first video clip list, and preloading the video clip corresponding to each of the one or more child nodes of the current node into the first play queue includes: acquiring a video clip corresponding the child node that is not included in the first play queue; and preloading the video clip corresponding to the child node that is not included in the first play queue based on the first video clip list.

In one embodiment, acquiring the video clip corresponding to each of the one or more child nodes of the current node from the first video clip list, and preloading the video clip corresponding to each of the one or more child nodes of the current node into the first play queue includes: determining whether a sum of data amounts occupied by video clips. each of which corresponding to each of the one or more child nodes of the current node, reaches a first preset threshold; and responsive to determining that the sum of the data amounts occupied by the video clips, each of which corresponding to each of the one or more child nodes of the current node, does not reach the first preset threshold, preloading the video clip corresponding to the each of the one or more child nodes into the first play queue.

In one embodiment, acquiring the video clip corresponding to each of the one or more child nodes of the current node from the first video clip list and preloading the video clip into the first play queue includes: determining whether a data amount occupied by the video clip corresponding to each of the one or more child nodes of the current node reaches a second preset threshold; and preloading the video clip of the child node which occupies the data amount not reaching the second preset threshold into the first play queue.

In one embodiment, the first video clip list includes a playing path of the video clip corresponding to each of nodes in the tree relationship; and acquiring, according to the target child node corresponding to the option selected by the user, the video clip corresponding to the target child node from the first video clip list, and playing the video clip corresponding to the target child node includes: acquiring, according to the target child node corresponding to the option selected by the user, the playing path of the video clip corresponding to the target child node from the first video clip list, and playing the video clip corresponding to the target child node.

In one embodiment, before determining the tree relationship of the video to be played and the first video clip list corresponding to the tree relationship according to the video clip information, the method further includes: determining whether a current play mode is an interactive preview play mode or a main-thread preview play mode; responsive to determining that the current play mode is the interactive preview play mode, proceeding to the step of determining the tree relationship of the video to be played and the first video clip list corresponding to the tree relationship according to the video clip information; and responsive to determining that the current play mode is the main-thread preview play mode, determining a main thread relationship of the video to be played and a second video clip list corresponding to the main thread relationship according to the video clip information, and playing the video to be played based on the main thread relationship and the second video clip list.

In one embodiment, the main thread relationship is a chain structure formed by a plurality of index objects, each index object corresponding to a video clip, and playing the video to be played based on the main thread relationship and the second video clip list includes: acquiring a video clip corresponding to a next index object from the second video clip list after playing of a video clip corresponding to a current index object in the main thread relationship is completed, and playing the video clip corresponding to the next index object.

In one embodiment, the video clip corresponding to the next index object is acquired from the second video clip list and preloaded into a second play queue when playing the video clip corresponding to the current index object in the main thread relationship; and acquiring the video clip corresponding to the next index object from the second video clip list, and playing the video clip corresponding to the next index object includes: acquiring the video clip corresponding to the next index object from the second play queue after preloaded, and playing the video clip corresponding to the next index object.

In one embodiment, after the playing of the video clip corresponding to the current index object in the main thread relationship is completed, the method further includes: determining whether a video clip corresponding to an index object following the current index object includes the video clip corresponding to the current index object; responsive to determining that the video clip corresponding to the index object following the current index object includes the video clip corresponding to the current index object, retaining the video clip corresponding to the current index object in the second play queue; and responsive to determining that the video clip corresponding to the index object following the current index object does not include the video clip corresponding to the current index object, deleting the video clip corresponding to the current index object from the second play queue.

In one embodiment, acquiring the video clip corresponding to the next index object from the second video clip list, and preloading the video clip corresponding to the next index object into the second play queue includes: determining whether the second play queue includes the video clip corresponding to the next index object; and responsive to determining that the second play queue does not include the video clip corresponding to the next index object, preloading the video clip corresponding to the next index object into the second play queue based on the second video clip list.

In one embodiment, acquiring the video clip corresponding to the next index object from the second video clip list, and preloading the video clip corresponding to the next index object into the second play queue includes: determining whether a data amount occupied by the video clip corresponding to the next index object reaches a third preset threshold; and responsive to determining that the data amount occupied by the video clip corresponding to the next index object does not reach the third preset threshold, preloading the video clip corresponding to the next index object into the second play queue.

In one embodiment, before acquiring the video clip information of the video to be played, the method further includes: acquiring path information of the video to be played, where the path information is local path information or network address information; and acquiring the video clip information of the video to be played includes: acquiring the video clip information of the video to be played according to the path information.

In one embodiment, displaying the option corresponding to each of the one or more child nodes of the current node includes: displaying a question corresponding to the current node and the option corresponding to each of the one or more child nodes of the current node.

### BRIEF DESCRIPTION OF THE DRAWINGS

In order to illustrate the technical solutions in the embodiments of the present disclosure more clearly, the drawings used in the description of the embodiments will be briefly described below. It is apparent that the drawings in the following description are only some embodiments of the present disclosure. For those skilled in the art, other drawings may also be obtained in accordance with the drawings without any inventive effort.

FIG. 1 is a flowchart of a method for playing a video provided in an embodiment of the present disclosure;

FIG. 2 is another flowchart of a method for playing the video provided in an embodiment of the present disclosure;

FIG. 3 is a schematic diagram showing a tree relationship in an interactive preview play mode provided in an embodiment of the present disclosure;

FIG. 4 is yet another flowchart of a method for playing the video provided in an embodiment of the present disclosure;

FIG. 5 is still a further flowchart of a method for playing the video provided in an embodiment of the present disclosure;

FIG. 6 is a flowchart of a sub-step 4031 of the method for playing the video in FIG. 5;

FIG. 7 is one additional flowchart of a method for playing the video provided in an embodiment of the present disclosure;

FIG. 8 is a schematic diagram of a main thread relationship in a main-thread preview play mode provided in an embodiment of the present disclosure.

FIG. 9 is one more flowchart of a method for playing the video provided in an embodiment of the present disclosure;

FIG. 10 is still one more flowchart of a method for playing the video provided in an embodiment of the present disclosure.

### DETAILED DESCRIPTION

In order to make the objective, the technical solutions and the advantages of the present disclosure clearer, a detailed description is made in the following with reference to the drawings. It is evident that the embodiments described herein are only some rather than all descriptions of the present disclosure. Based on the embodiments in the present disclosure, all other embodiments obtained by those skilled in the art without any inventive effort fall within the protection scope of the present disclosure.

The present disclosure discloses a method for playing a video which is applied to an electronic device, for example, a mobile terminal such as a mobile phone, a tablet computer and the like. This embodiment provides a manner of video on demand (VOD) in an interactive preview play mode. That is, a user may perform VOD in an interactive mode.

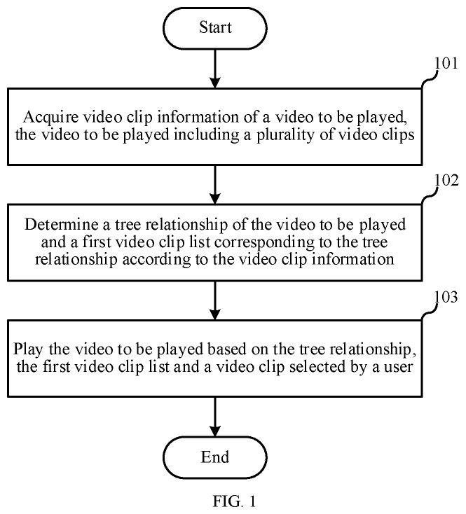

A specific flow of the method for playing the video is shown as FIG. 1.

In step 101, video clip information of a video to be played is acquired, and the video to be played includes a plurality of video clips.

Specifically, the user may perform VOD through on-demand software installed in an electronic device. When receiving a program on demand selected by the user, the electronic device acquires video clip information of a video corresponding to the on-demand program, i.e., video clip information of the video to be played. Herein, each video to be played may include a plurality of video clips, the video clip information includes related information of the plurality of video clips, and the related information may include information regarding associations between the video clips and a playing path of each of the video clips.

In this embodiment, the electronic device may acquire path information of the video to be played first, and acquire the video clip information according to the path information. Herein, the path information is local path information or network address information. Specifically, the electronic device acquires the path information of the video to be played first. If the path information is the local path information, it means that the video to be played is a video stored locally. Thus, the video clip information of the video to be played is acquired from the electronic device based on the local path information. If the path information is the network address information (which may be uniform resource locator (URL)), it means that the video to be played is stored in a remote terminal or server. Thus, the video clip information of the video to be played is acquired from the remote terminal or server according to the network address information.

In step 102, a tree relationship of the video to be played and a first video clip list corresponding to the tree relationship are determined according to the video clip information.

Specifically, a tree relationship in the interactive preview play mode may be determined according to the information regarding associations between the video clips included in the video clip information. Each of nodes in the tree relationship corresponds to one video clip, and the video clip information includes a playing path of each of the video clips. Thus, a first video clip list corresponding to the tree relationship may be generated based on the tree relationship, and the first video clip list includes the playing path of each of the video clips corresponding to each of the nodes in the tree relationship.

In step 103, the video to be played is played based on the tree relationship, the first video clip list, and a video clip selected by a user.

Specifically, after determining the tree relationship in the interactive preview play mode and the first video clip list corresponding to the tree relationship, the electronic device acquires, based on the video clip selected by the user during interacting with the electronic device, a playing path of the selected video clip from the first video clip list, and then may play the selected video clip until the user pauses or stops playing, or playing of the video clips corresponding to all nodes on any node path in the tree relationship is completed. Herein, the node path is a path formed from a root node to a leaf node in the tree relationship.

Compared with existing technologies, this embodiment provides a manner of VOD in the interactive preview play mode. During playing an on-demand video requested by a user, video clip information of the video to be played which includes a plurality of video clips is acquired first. Then, the tree relationship of the video to be played in an interactive preview play mode and the first video clip list corresponding to the tree relationship are determined according to the video clip information. Subsequently, the video clip of the video to be played that corresponds to the node contained in the tree relationship may be played based on the video clip selected by the user during interacting with the electronic device and the first video clip list. In this way, VOD experience in an interactive mode is provided to the user, so that the user may select and play the video clip through interaction with video content, thereby improving user's interest in VOD.

The present disclosure further discloses another method for playing the video. Compared with the above embodiment, this embodiment is more detailed in providing a specific implementation of playing the video to be played based on the tree relationship, the first video clip list corresponding to the tree relationship, and the video clip selected by the user.

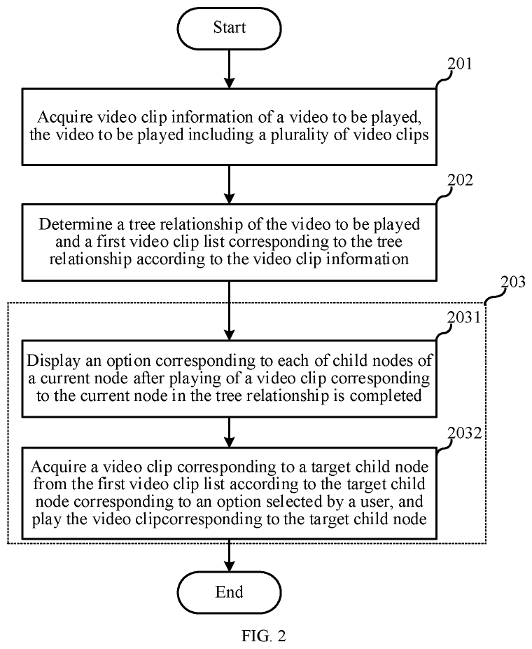

A specific flow of the method for playing the video in this embodiment is shown in FIG. 2.

In step 201, video clip information of a video to be played is acquired, and the video to be played includes a plurality of video clips. Details for this step are approximately the same as that of step 101 in the above embodiment and thus are not repeated herein.

In step 202, a tree relationship of the video to be played and a first video clip list corresponding to the tree relationship are determined according to the video clip information. Details for this step are approximately the same as that of step 102 in the above embodiment and thus are not repeated herein.

Step 203 includes the following sub-steps.

In sub-step 2031, an option corresponding to each of one or more child nodes of a current node is displayed after playing of a video clip corresponding to the current node in the tree relationship is completed.

Specifically, the first video clip list includes a playing path of the video clip corresponding to each of nodes in the tree relationship, and each of video clips in the first video clip list corresponds to one clip identifier, thereby establishing correspondence between the clip identifier of the video clip and the playing path of the video clip. When playing the video clip corresponding to the current node, a clip identifier of the video clip corresponding to the current node is acquired. Then, the first video clip list is queried to obtain a playing path of the clip identifier, i.e., the playing path of the video clip corresponding to the current node, and the video clip corresponding to the current node is played based on the playing path. When the playing of the video clip corresponding to the current node is completed, an option corresponding to each of the one or more child nodes of the current node is displayed on a display unit (for example, a display screen) of the electronic device for the user to select a next video clip to be played.

In one example, displaying the option corresponding to each of the one or more child nodes of the current node includes: displaying a question corresponding to the current node and the option corresponding to each of the one or more child nodes of the current node. Specifically, in the tree relationship, a leaf node is an outermost node. Each of nodes except for the leaf node has a corresponding problem and at least one child node. When the playing of the video clip corresponding to the current node is completed, the problem corresponding to the current node and the option corresponding to each of the one or more child nodes of the current node are displayed on the display unit (for example, the display screen) of the electronic device. For example, the problem corresponding to the current node may be “please select a scenario you would like to enter”. Options of a plurality of child nodes corresponding to the current node represent different scenarios respectively. When the user selects a certain scenario, a video clip that corresponds to a child node corresponding to the scenario is played.

In sub-step 2032, the video clip corresponding to a target child node is acquired from the first video clip list according to the target child node corresponding to the option selected by the user and is played.

Specifically, when the option selected by the user is received, the child node corresponding to the option, i.e., the target child node, is acquired. Then, a clip identifier of the video clip corresponding to the target child node is acquired, the first video clip list is queried, and a playing path corresponding to the clip identifier, i.e., a playing path of the video clip corresponding to the target node, is acquired. And then, the video clip corresponding to the target node is played based on the playing path. After the playing of the video clip corresponding to the target node is completed, the above process is repeated until the user pauses or stops playing, or playing of the video clips corresponding to all nodes on any node path in the tree relationship is completed.

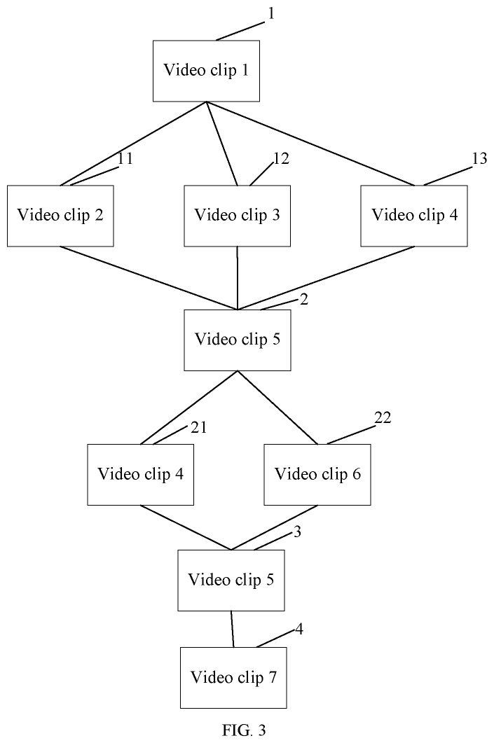

The step 203 is described with reference to a tree relationship in an interactive preview play mode as shown in FIG. 3. The first video clip list includes clip identifiers of video clips 1 to 7 and playing paths of the video clips 1 to 7 in one-to-one correspondence with the clip identifiers.

During playing video on demand, the playing starts from a root node 1 in the tree relationship, and a clip identifier of a video clip 1 corresponding to the root node 1 is acquired. Then, the first video clip list is queried to obtain a playing path corresponding to the clip identifier, i.e., a playing path of the video clip 1 corresponding to the root node 1, and the video clip 1 corresponding to the root node 1 is played based on the playing path. When the playing of the video clip 1 is completed, an option corresponding to each of the one or more child nodes (which include a node 11, a node 12 and a node 13) of the root node 1 is displayed on the display unit (for example, a display screen) of the electronic device.

It is assumed that the user selects an option corresponding to the node 11, and a clip identifier of a video clip 2 corresponding to the node 11 is acquired. And then the first video clip list is queried to obtain a playing path corresponding to the clip identifier of the video clip 2, i.e., a playing path of the video clip 2, and the video clip 2 is played based on the playing path. When the playing of the video clip 2 is completed, an option corresponding to a child node (i.e., a node 2) of the node 11 is displayed on the display unit of the electronic device. Since there is only one option at this time, an option representing skipping, an option representing returning to reselect and an option representing pausing or stopping playing may further be displayed on the display unit.

It is assumed that the user selects an option corresponding to the node 2, and a clip identifier of a video clip 5 corresponding to the node 2 is acquired. And then the first video clip list is queried to obtain a playing path corresponding to the clip identifier of the video clip 5, i.e., a playing path of the video clip 5, and the video clip 5 is played based on the playing path. When the playing of the video clip 5 is completed, an option corresponding to each of the one or more child nodes (which include a node 21 and a node 22) of the node 2 is displayed on the display unit of the electronic device.

It is assumed that the user selects an option corresponding to the node 21, and a clip identifier of a video clip 4 corresponding to the node 21 is acquired. And then the first video clip list is queried to obtain a playing path corresponding to the clip identifier of the video clip 4, i.e., a playing path of the video clip 4, and the video clip 4 is played based on the playing path. When the playing of the video clip 4 is completed, an option corresponding to a child node (i.e., a node 3) of the node 21 is displayed on the display unit of the electronic device. Since there is only one option at this time, an option representing skipping, an option representing returning to reselect and an option representing pausing or stopping playing may further be displayed on the display unit.

It is assumed that the user selects an option corresponding to the node 3, and a clip identifier of a video clip 5 corresponding to the node 3 is acquired. And then the first video clip list is queried to obtain a playing path corresponding to the clip identifier of the video clip 5, i.e., a playing path of the video clip 5, and the video clip 5 is played based on the playing path. When the playing of the video clip 5 is completed, an option corresponding to a child node (i.e., a node 4) of the node 3 is displayed on the display unit of the electronic device. When the user selects an option corresponding to the node 4, a clip identifier of a video clip 7 corresponding to the node 4 is acquired. And then the first video clip list is queried to obtain a playing path corresponding to the clip identifier of the video clip 7, i.e., a playing path of the video clip 7, and the video clip 7 is played based on the playing path. When the playing of the video clip 7 is completed, it means that the playing of VOD this time is over because the node 4 does not have a child node.

Compared with the above embodiment, this embodiment provides a specific implementation of playing the video to be played based on the tree relationship, the first video clip list corresponding to the tree relationship, and the video clip selected by the user.

The present disclosure further provides another method for playing the video. Compared with the above embodiment, a main improvement of this embodiment is that a video clip is preloaded.

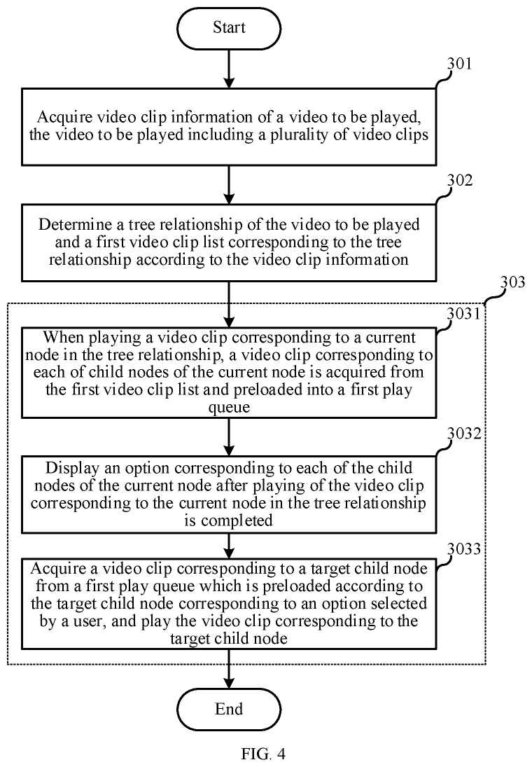

A specific flow of the method for playing the video in this embodiment is shown in FIG. 4.

In step 301, video clip information of a video to be played is acquired, and the video to be played includes a plurality of video clips. Details for this step are approximately the same as that of step 101 in the above embodiment and thus are not repeated herein.

In step 302, a tree relationship of the video to be played and a first video clip list corresponding to the tree relationship are determined according to the video clip information. Details for this step are approximately the same as that of step 102 in the above embodiment and thus are not repeated herein.

Step 303 includes the following sub-steps.

In sub-step 3031, a video clip corresponding to each of one or more child nodes of a current node is acquired from the first video clip list when playing the video clip corresponding to the current node in the tree relationship, and the video clip corresponding to each of the one or more child nodes of the current node is preloaded into a first play queue.

Specifically, each of the video clips in the first video clip list corresponds to one clip identifier, thereby establishing correspondence between the clip identifier of the video clip and a playing path of the video clip. When playing the video clip corresponding to the current node, a clip identifier of the video clip corresponding to the current node is acquired, And then the first video clip list is queried to obtain a playing path of the clip identifier, i.e., a playing path of the video clip corresponding to the current node, and the video clip corresponding to the current node is played based on the playing path. During playing the video clip corresponding to the current node, a clip identifier of the video clip corresponding to each of the one or more child nodes of the current node is acquired. Subsequently, a playing path of the video clip corresponding to each of the one or more child nodes is acquired from the first video list, and the video clip corresponding to each of the one or more child nodes is preloaded into the first play queue based on the playing path of the video clip corresponding to each of the one or more child nodes.

Take a root node 1 in FIG. 3 being the current node as an example. When playing a video clip 1 corresponding to the root node 1, all child nodes including a node 11, a node 12 and a node 13 of the root node 1 are traversed. Video clips corresponding to the node 11, the node 12 and the node 13 are respectively acquired to obtain a to-be-interactively-selected video list after playing of the video clip 1 corresponding to the root node 1 is completed. The to-be-interactively-selected video list includes playing paths corresponding to a video clip 2, a video clip 3 and a video clip 4. Then, playing instances are created sequentially and preloaded into the first play queue, each of the video clips corresponding to one playing instance. Herein, after preloading of all video clips in the to-be-interactively-selected video list is completed, the to-be-interactively-selected video list may be initialized, i.e., deleting a playing instance of a video clip that has already been preloaded into the first play queue from the to-be-interactively-selected video list.

In one example, acquiring the video clip corresponding to each of the one or more child nodes of the current node from the first video clip list and preloading the video clip corresponding to each of the one or more child nodes of the current node into the first play queue includes: determining whether a sum of data amounts occupied by video clips, each of which corresponding to each of the one or more child nodes of the current node, reaches a first preset threshold; and responsive to determining that the sum of the data amounts occupied by the video clips, each of which corresponding to each of the one or more child nodes of the current node, does not reach the first preset threshold, preloading the video clip corresponding to each of the one or more child nodes into the first play queue. Specifically, the first preset threshold is preset in the electronic device. The first preset threshold is an upper limit value of a total data amount occupied by video clips corresponding to all the child nodes of the current node. That is, the first preset threshold is used to limit the total data amount occupied by the video clips that are loaded in the first play queue each time. Take the root node 1 in FIG. 3 being the current node as an example. When playing the video clip 1 corresponding to the root node 1, all child nodes including the node 11, the node 12 and the node 13 of the root node 1 are traversed. Video clips (including the video clip 2, the video clip 3 and the video clip 4) corresponding to the node 11, the node 12 and the node 13 are respectively acquired. Then a sum of data amounts occupied by the video clip 2, the video clip 3 and the video clip 4 is calculated, and it is determined whether the sum of the data amounts reaches the first preset threshold. If the sum of the data amounts reaches the first preset threshold, it means that the data amount occupied by preloading this time excesses a preset limit and thus the preloading this time is stopped. That is, the playing instances of the video clip 2, the video clip 3 and the video clip 4 may not be preloaded into the first play queue. If the sum of the data amounts does not reach the first preset threshold, it means that the data amount occupied by preloading this time does not excess the preset limit and the playing instances of the video clip 2, the video clip 3 and the video clip 4 may be preloaded into the first play queue. In this way, the data amounts of the video clips preloaded into the first play queue may be prevented from excessing the preset limit, thereby not affecting performance of the electronic device.

In one example, acquiring the video clip corresponding to each of the one or more child nodes of the current node from the first video clip list, and preloading the video clip corresponding to each of the one or more child nodes of the current node into the first play queue includes: determining whether a data amount occupied by the video clip corresponding to each of the one or more child nodes of the current node reaches a second preset threshold; and preloading the video clip of the child node which occupies the data amount not reaching the second preset threshold into the first play queue. Specifically, the second preset threshold is preset in the electronic device. The second preset threshold is an upper limit value of the data amount occupied by the video clip corresponding to a child node of the current node. That is, the second preset threshold is used to limit the data amount occupied by each of the video clips loaded in the first play queue. Take the root node 1 in FIG. 3 being the current node as an example. When playing the video clip 1 corresponding to the root node 1, all child nodes including the node 11, the node 12 and the node 13 of the root node 1 are traversed. Video clips (including the video clip 2, the video clip 3 and the video clip 4) corresponding to the node 11, the node 12 and the node 13 are respectively acquired. Then it is determined whether the data amounts respectively occupied by the video clip 2, the video clip 3 and the video clip 4 reach the second preset threshold. If a data amount occupied by a video clip reaches the second preset threshold, the playing instance of the video clip may not be preloaded into the first play queue. If a data amount occupied by a video clip does not reach the second preset threshold, the playing instance of the video clip may be preloaded into the first play queue. By limiting a data amount occupied by a video clip corresponding to a single node, the data amounts of video clips preloaded into the first play queue may be prevented from excessing a present limit, thereby not affecting performance of the electronic device.

It should be noted that in this embodiment, data amounts occupied by video clips that have been already loaded into the first play queue may further be determined. If the data amounts occupied by the video clips that have been already loaded into the first play queue excess a preset threshold, the video clip is no longer loaded into the first play queue.

In sub-step 3032, an option corresponding to each of the one or more child nodes of the current node is displayed after playing of the video clip corresponding to the current node in the tree relationship is completed. Details for this step are approximately the same as that of sub-step 2031 in the above embodiment and thus are not repeated herein.

In sub-step 3033, a video clip corresponding to a target child node is acquired from a first play queue after preloaded according to the target child node corresponding to the option selected by the user, and the video clip corresponding to the target child node is played.

Specifically, when the option selected by the user is received, a child node corresponding to the option, i.e., a target child node, is acquired. Then, a clip identifier of the video clip corresponding to the target child node is acquired, and a playing instance of the video clip corresponding to the clip identifier is read from the first play queue and is played.

Compared with the above embodiment, the video clip to be selected may be preloaded into the first play queue in this embodiment, so that the user may directly perform the loading and the playing of the video clip in the first playing list when selecting any one of the video clips, thereby improving efficiency of playing the video clip.

The present disclosure further discloses another method for playing the video. Compared with the above embodiment, a main improvement of this embodiment is that reuse and deduplication of the video clip in the first play queue are realized.

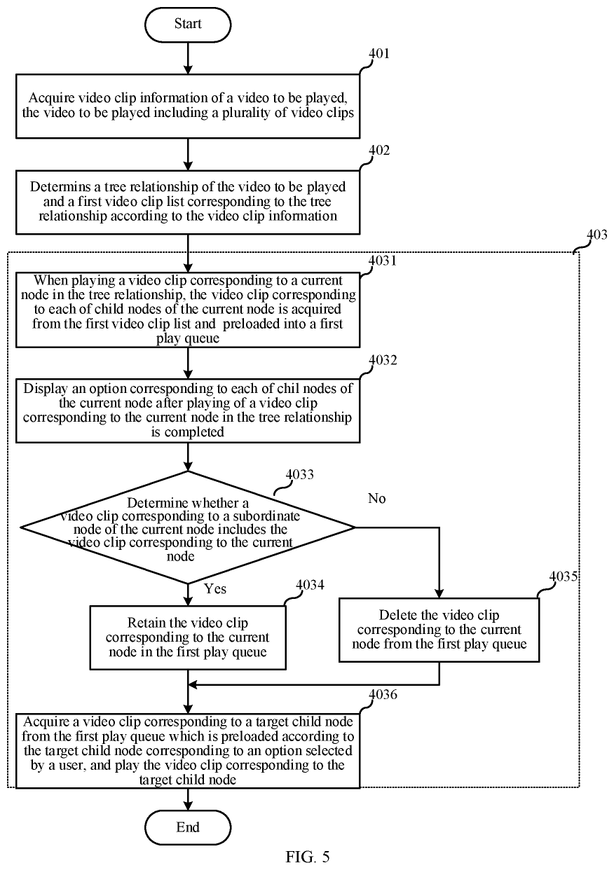

A specific flow of the method for playing the video in this embodiment is shown in FIG. 5.

In step 401, video clip information of a video to be played is acquired, and the video to be played includes a plurality of video clips. Details for this step are approximately the same as that of step 101 in the above embodiment and thus are not repeated herein.

In step 402, a tree relationship of the video to be played and a first video clip list corresponding to the tree relationship are determined according to the video clip information. Details for this step are approximately the same as that of step 102 in the above embodiment and thus are not repeated herein.

Step 403 includes the following sub-steps.

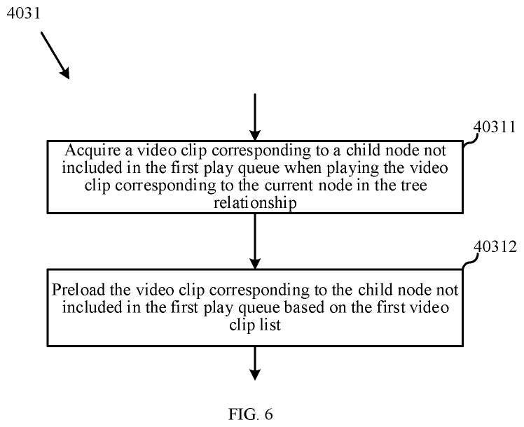

Sub-step 4031, with reference to FIG. 6, further includes the following sub-steps.

In sub-step 40311, a video clip corresponding to a child node not included in a first play queue is acquired when playing a video clip corresponding to a current node in the tree relationship.

In sub-step 40312, the video clip corresponding to the child node not included in the first play queue is preloaded based on the first video clip list.

Specifically, each of the video clips in the first video clip list corresponds to one clip identifier, thereby establishing correspondence between the clip identifier of the video clip and a playing path of the video clip. When playing the video clip corresponding to the current node, a clip identifier of the video clip corresponding to the current node is acquired. And then the first video clip list is queried to obtain a playing path of the clip identifier, i.e., a playing path of the video clip corresponding to the current node, and the video clip corresponding to the current node is played based on the playing path. During playing the video clip corresponding to the current node, a clip identifier of the video clip corresponding to each of the one or more child nodes of the current node is acquired. Subsequently, clip identifiers of the video clips having been loaded into the first play queue are traversed to determine whether a clip identifier of a video clip corresponding to any one of child nodes exists in the first play queue, i.e., to determine whether the video clip corresponding to any one of the child nodes has already been loaded into the first play queue. For each of the one or more child nodes, if a video clip corresponding to the child node has already been preloaded into the first play queue, the video clip corresponding to the child node may no longer be loaded repeatedly. If the video clip of the child node is not preloaded into the first play queue, a playing path of the video clip corresponding to the child node may be acquired from the first video clip list, and a playing instance of the video clip corresponding to the child node may be loaded into the first play queue.

The tree relationship in the interactive preview play mode in FIG. 3 is again taken as an example. When playing the video clip 1 corresponding to the root node 1, the video clip 2, the video clip 3 and the video clip 4 may be preloaded into the first play queue. In this way, when playing the video clip 5 corresponding to the node 2, only a video clip 6 is needed to be loaded into the first play queue since the video clip 4 has already been loaded into the first play queue. Similarly, when the video clip 4 or the video clip 6 is selected by the user for playing, there is no need to preload the video clip 5 into the first play queue.

In sub-step 4032, an option corresponding to each of the one or more child nodes of the current node is displayed after playing of the video clip corresponding to the current node in the tree relationship is completed. Details for this step are approximately the same as that of sub-step 2031 in the above embodiment and thus are not repeated herein.

In sub-step 4033, it is determined whether a video clip corresponding to a node subordinating to the current node includes the video clip corresponding to the current node. If the video clip corresponding to the current node is included in the video clip corresponding to the node subordinating to the current node, proceeding to sub-step 4034. If the video clip corresponding to the current node is not included in the video clip corresponding to the node subordinating to the current node, proceeding to sub-step 4035.

In sub-step 4034, the video clip corresponding to the current node is retained in the first play queue.

In sub-step 4035, the video clip corresponding to the current node is deleted from the first play queue.

Specifically, after the playing of the video clip corresponding to the current node is completed, video clips corresponding to all nodes subordinating to the current node are traversed to determine whether the video clip corresponding to the current node is included therein. That is, a clip identifier of the video clip corresponding to the current node is compared with clip identifiers of the video clips corresponding to the nodes subordinating to the current node. When there is a clip identifier of a video clip corresponding to any one of the nodes subordinating to the current node that matches the clip identifier of the video clip corresponding to the current node, the video clip of the current node is retained in the first play queue. Otherwise, the video clip corresponding to the current node is deleted from the first play queue.

The tree relationship in the interactive preview play mode in FIG. 3 is again taken as an example. After playing of the video clip 4 corresponding to the node 13 is completed, all nodes subordinating to the node 13 (including the node 2, the node 21, the node 22, the node 3 and the node 4) of the node 13 are traversed, and it is determined that a video clip corresponding to the node 21 is the same as the video clip corresponding to the node 13. At this time, the video clip 2, the video clip 3 and the video clip 4 have already been preloaded into the first play queue, thus there is no need to delete the video clip 4 from the first play queue. In one example, when playing the video clip 4 corresponding to the node 13, the above determination may also be performed on the node 11 and the node 12 that are on the same level as the node 13, i.e., respectively determining whether a node corresponding to the video clip 2 is included in all nodes subordinating to the node 11 and whether a node corresponding to the video clip 3 is included in all nodes subordinating to the node 12. It is known that the node corresponding to the video clip 2 is not included in all the nodes subordinating to the node 11 and the node corresponding to the video clip 3 is not included in the nodes subordinating to the node 12, at this time, the video clip 2 and the video clip 3 may be deleted from the first play queue.

In sub-step 4036, the video clip corresponding to the target child node is acquired from the first play queue after preloaded according to the target child node corresponding to the option selected by the user, and the video clip corresponding to the child node is played. Details for this step are approximately the same as that of the sub-step 3033 in the above embodiment and thus are not repeated herein.

Compared with the above embodiment, reuse of the video clip is realized in this embodiment when performing a preloading operation on the first play queue, thereby times of loading the video clip is reduced. At the same time, only the video clip corresponding to the child node not included in the first play queue is loaded, so that repeated loading of the video clip is avoided.

The present disclosure further discloses another method for playing the video. Compared with the above embodiments, a main improvement of this embodiment is that a manner of VOD in a main-thread preview play mode is further provided on the basis of the manner of VOD in the interactive preview play mode provided in the above embodiment.

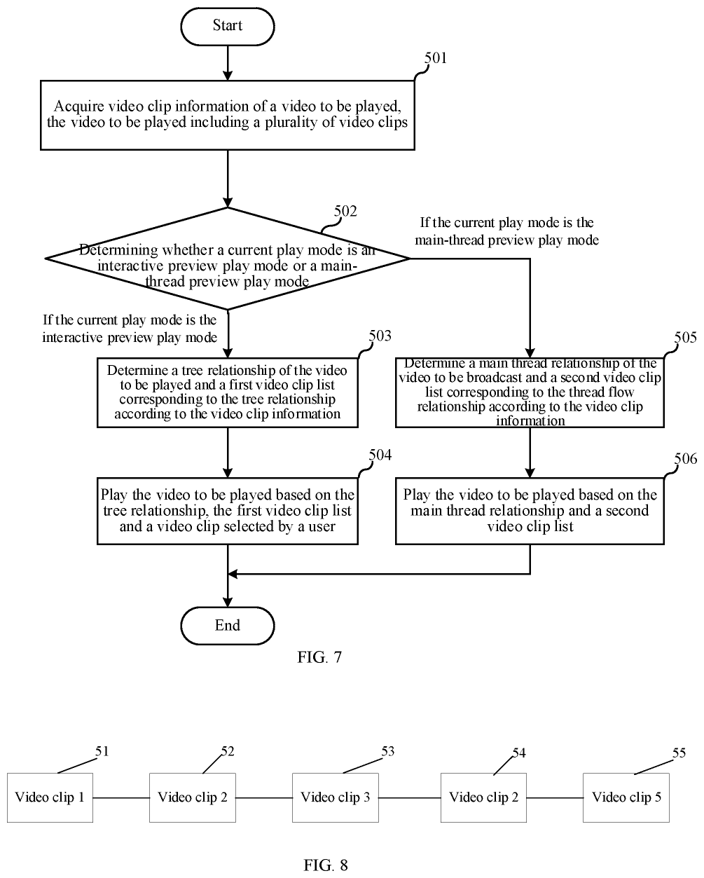

A specific flow of the method for playing the video is shown in FIG. 7.

In step 501, video clip information of a video to be played is acquired, and the video to be played includes a plurality of video clips. Details for this step are approximately the same as that of the step 101 in the above embodiment and thus are not repeated herein.

In step 502, whether a current play mode is an interactive preview play mode or a main-thread preview play mode. If the current play mode is the interactive preview play mode, proceeding to step 503. If the current play mode is the main-thread preview play mode, proceeding to step 505.

In step 503, a tree relationship of the video to be played and a first video clip list corresponding to the tree relationship are determined according to the video clip information. Details for this step are approximately the same as that of step 102 in the above embodiment and thus are not repeated herein.

In step 504, the video to be played is played based on the tree relationship, the first video clip list, and a video clip selected by a user. Details for this step are approximately the same as that of step 103 in the above embodiment and thus are not repeated herein.

In step 505, a main thread relationship of the video to be played and a second video clip list corresponding to the main thread relationship are determined according to the video clip information.

Specifically, the main thread relationship in the main-thread preview play mode may be determined according to information of association between the video clips included in the video clip information. The main thread relationship is a chain structure formed by a plurality of index objects. Each of the index objects corresponds to one video clip, and the video clip information includes a playing path of each of video clips. Therefore, a second video clip list corresponding to the main thread relationship may be generated based on the main thread relationship, and the second video clip list includes the playing path of the video clip corresponding to each of the index objects in the main thread relationship.

In step 506, the video to be played is played based on the main thread relationship and the second video clip list.

Specifically, playing paths of the video clips corresponding to the index objects are acquired sequentially from the second video clip list according to a chain relationship between the index objects in the main thread relationship, and the video clips corresponding to the index objects are played.

The following is a description of the main thread relationship in the main-thread preview play mode with reference to FIG. 8. The second video clip list includes the playing path of the video clip corresponding to each of the index objects in the main thread relationship. In the second video clip list, each of the video clips corresponds to one clip identifier, thereby establishing correspondence between the clip identifier of the video clip and the playing path of the video clip.

During playing video on demand, the playing starts from a first index object 51 in the main thread relationship. A clip identifier of a video clip 1 corresponding to the index object 51 is acquired. Then the second video clip list is queried to obtain a playing path corresponding to the clip identifier, i.e., a playing path of the video clip 1 corresponding to the index object 51, and the video clip 1 corresponding to the index object 51 is played based on the playing path. When the playing of the video clip 1 is completed, a clip identifier of a video clip 2 corresponding to a next index object 52 is acquired. Then the second video clip list is queried to obtain a playing path of the clip identifier, i.e., a playing path of the video clip 2 corresponding to the index object 52, and the video clip 2 corresponding to the index object 52 is played based on the playing path. When the playing of the video clip 2 is completed, the above process is repeated until the user pauses or stops playing, or playing of a video clip 5 corresponding to a last index object 55 is completed.

Compared with the above embodiment, in this embodiment, the manner of VOD in the main-thread preview play mode is further provided to the electronic device for the user to select a manner of VOD as required, thereby improving experience of the user.

The present disclosure further discloses another method for playing the video. Compared with the above embodiment, a main improvement of this embodiment is that a video clip is preloaded.

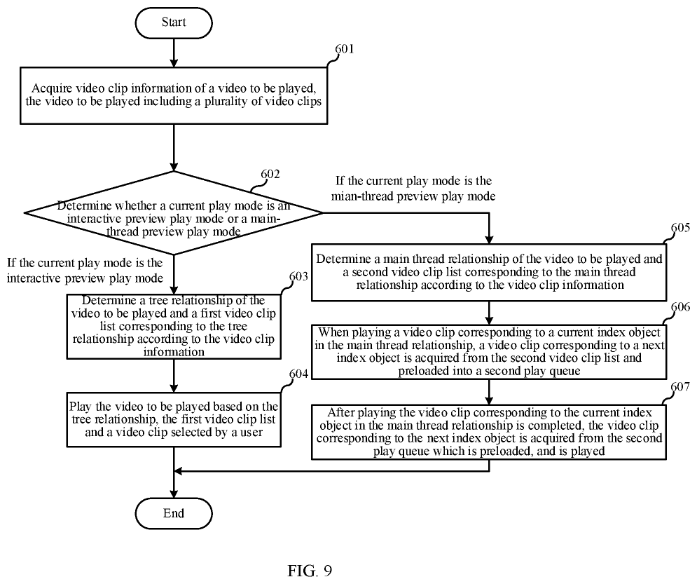

A specific flow of the method for playing the video in this embodiment is shown in FIG. 9.

Herein, details for steps 601 to 605 are approximately the same as that of steps 501 to 505 and thus are not repeated. The method in this embodiment is mainly different in the following.

In step 606, when playing a video clip corresponding to a current index object in a main thread relationship, a video clip corresponding to a next index object is acquired from a second video clip list and preloaded into a second play queue.

Specifically, the second video clip list includes a playing path of a video clip corresponding to each of index objects in the main thread relationship, and each of video clips in the second video clip list corresponds to one clip identifier, thereby establishing correspondence between the clip identifier of the video clip and the playing path of the video clip. When playing the video clip corresponding to the current index object, a clip identifier of the video clip corresponding to the current index object is acquired. Then, the second video clip list is queried to obtain a playing path of the clip identifier, i.e., a playing path of the video clip corresponding to the current index object, and the video clip corresponding to the current index object is played based on the playing path. When playing the video clip corresponding to the current index object, a clip identifier of a video clip corresponding to a next index object is acquired. Then, the second video clip list is queried to obtain a playing path of the video clip corresponding to the clip identifier, and the video clip corresponding to the next index object is preloaded into the second play queue based on the playing path.

Take an index object 51 in FIG. 8 being a current index object as an example. When playing the video clip 1 corresponding to the index object 51, the video clip 2 corresponding to the index object 52 is acquired. Then, a playing instance of the video clip 2 is created and preloaded into the second play queue based on a playing path of the video clip 2 in the second video clip list.

In one example, acquiring the video clip corresponding to the next index object from the second video clip list and preloading the video clip corresponding to the next index object into the second play queue includes: determining whether a data amount occupied by the video clip corresponding to the next index object reaches a third preset threshold; and responsive to determining that the data amount occupied by the video clip corresponding to the next index object does not reach the third preset threshold, preloading the video clip corresponding to the next index object into the second play queue. Specifically, the third preset threshold is preset in the electronic device. The third preset threshold is an upper limit value of the data amount occupied by the video clip corresponding to the next index object. That is, the third preset threshold is used to limit the data amount occupied by the video clip corresponding to each of the index objects loaded in the second play queue. Take the index object 51 in FIG. 8 being the current index object as an example. When playing the video clip 1 corresponding to the index object 51, the video clip 2 corresponding to the next index object 52 is acquired. Then, it is determined whether a data amount occupied by the video clip 2 reaches the third preset threshold. If the data amount occupied by the video clip 2 reaches the third preset threshold, a playing instance of the video clip 2 may not be preloaded into the second play queue. If the data amount occupied by the video clip 2 does not reach the third preset threshold, the playing instance of the video clip 2 may be preloaded into the second play queue. By limiting a data amount occupied by a video clip corresponding to a single index object, the data amounts of video clips preloaded into the second play queue may be prevented from exceeding a preset limit, thereby not affecting performance of the electronic device.

In step 607, after the playing of the video clip corresponding to the current index object in the main thread relationship is completed, the video clip corresponding to the next index object is acquired from the second play queue after preloaded, and the video clip corresponding to the next index object is played.

Specifically, after the playing of the video clip corresponding to the current index object is completed, a playing instance of the video clip corresponding to the next index object is read from the second play queue and played.

Compared with the above embodiment, the video clip to be selected may be preloaded into the second play queue in this embodiment, so that the video clip corresponding to the next index object may be loaded and played directly from the second play queue, thereby improving efficiency of playing the video clip.

The present disclosure further discloses another method for playing the video. Compared with the above embodiment, a main improvement of this embodiment is that reuse and deduplication of the video clip in the second play queue are realized.

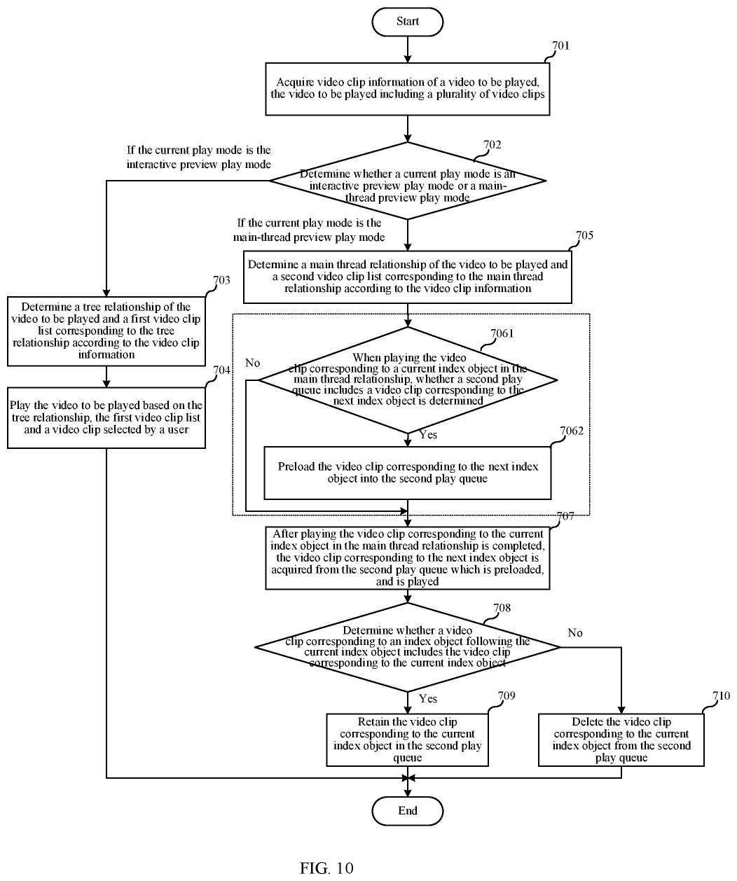

A specific flow of the method for playing the video in this embodiment is shown in FIG. 10.

Herein, details for steps 701 to 705 are approximately the same as that of steps 501 to 505 and thus are not repeated. The method in this embodiment is mainly different in the following.

Step 706 includes the following sub-steps.

In sub-step 7061, when playing a video clip corresponding to a current index object in a main thread relationship, determining whether a second play queue includes a video clip corresponding to a next index object. If the video clip corresponding to the next index object is included in the second play queue, proceeding to step 707. If the video clip corresponding to the next index object is not included in the second play queue, proceeding to step 7062.

In sub-step 7062, the video clip corresponding to the next index object is preloaded into the second play queue.

Specifically, during playing the video clip corresponding to the current index object, a clip identifier of the video clip corresponding to the next index object is acquired. Subsequently, clip identifiers of video clips having been loaded into the second play queue are traversed to determine whether a clip identifier of the video clip corresponding to the next index object exists in the second play queue, i.e., to determine whether the video clip corresponding to the next index object has already been loaded into the second play queue. If the video clip corresponding to the next index object has already been preloaded into the second play queue, the video clip corresponding to the next index object may no longer be loaded repeatedly. If the video clip corresponding to the next index object is not preloaded into the first play queue, a playing path of the video clip corresponding to the next index object may be acquired from the second video clip list, and a playing instance of the video clip corresponding to the next index object may be loaded into the second play queue.

The main thread relationship in the main-thread preview play mode in FIG. 8 is taken as an example. When playing the video clip 1 corresponding to the index object 51, the video clip 2 corresponding to the index object 52 may be preloaded into the second play queue. In this way, during playing the video clip 3 corresponding to the index object 53, the video clip 2 may not be preloaded into the second play queue at this time since the video clip 2 has already been preloaded into the second play queue.

In step 707, after the playing of the video clip corresponding to the current index object in the main thread relationship is completed, the video clip corresponding to the next index object is acquired from the second play queue after preloaded and the video clip corresponding to the next index object is played. Details for this step are approximately the same as that of step 607 in the above embodiment and thus are not repeated herein.

In step 708, it is determined whether a video clip corresponding to an index object following the current index object includes the video clip corresponding to the current index object. If the video clip corresponding to the index object following the current index object includes the video clip corresponding to the current index object, proceeding to step 709. If the video clip corresponding to the index object following the current index object does not include the video clip corresponding to the current index object, proceeding to step 710.

In step 709, the video clip corresponding to the current index object is retained in the second play queue.

In step 710, the video clip corresponding to the current index object is deleted from the second play queue.

Specifically, after the playing of the video clip corresponding to the current index object is completed, it is determined whether the video clip corresponding to the index object following the current index object includes the video clip corresponding to the current index object. At this point, a clip identifier of the video clip corresponding to the current index object may be compared sequentially with clip identifiers of video clips corresponding to subsequent index objects. When there is a clip identifier of a video clip corresponding to any of the index objects that matches the clip identifier of the video clip corresponding to the current index object, the video clip corresponding to the current index object is retained in the second play queue. Otherwise, the video clip corresponding to the current index object is deleted from the second play queue.

The main thread relationship in the main-thread preview play mode in FIG. 8 is taken as an example. During playing the video clip 1 corresponding to the index object 51, the video clip 2 corresponding to the index object 52 may be preloaded into the second play queue. During playing the video clip 2 corresponding to the index object 52, the video clip 3 corresponding to the index object 53 may be preloaded into the second play queue. When the playing of the video clip 2 corresponding to the index object 52 is completed, it is determined that an index object 54 corresponds to the video clip 2. At this point, the video clip 2 in the second play queue is retained. When the playing of the video clip 3 corresponding to the index object 53 is completed, it is determined that there is no subsequent index object that corresponds to the video clip 3. At this point, the video clip 3 in the second play queue is deleted.

Compared with the above embodiment, reuse of the video clip is realized in this embodiment when performing a preloading operation on the second play queue, thereby times of loading the video clip is reduced. At the same time, only the video clip corresponding to the next index object not included in the second play queue is loaded, so that repeated loading of the video clip is avoided.

The present disclosure further provides an electronic device, for example, a mobile terminal such as a mobile phone, a tablet computer and the like. The electronic device includes at least one processor, and includes a memory communicatively coupled to the at least one processor. Herein, the memory stores an instruction executable by the at least one processor which, when executed by the at least one processor, causes the at least one processor to perform the method for playing the video described above.

Herein, the memory and the processor are connected through a bus. The bus may include any number of buses and bridges that are interconnected with each other. The bus connects one or more processors with various circuits of the memory. The bus may further connect various other circuits such as a peripheral device, a regulator and a power management circuit, which are commonly known in the prior art and thus are not further described herein. A bus interface is an interface provided between the bus and a transceiver. The transceiver may be an element or a plurality of elements such as a plurality of receivers and transmitters, which provide units for communicating with various other devices on a transmitting medium. Data processed through the processor is transmitted on a wireless medium through an antenna. Further, the antenna further receives data and transmits the data to the processor.

The processor manages the bus and general processing, and may have various functions including timing, a peripheral interface, voltage regulation, power supply management as well as other control functions. The memory may be used to store data used by the processor when implementing an operation.

The present disclosure further provides a non-transitory computer readable storage medium storing a computer program which, when executed by the processor, causes the processor to perform the method in the above embodiments.

That is, those skilled in the art may understand that all or some steps of the methods in the above embodiments may be completed through a program instructing related hardware. The program is stored in a storage medium, which includes several instructions that enable a device (which may be a single-chip microcomputer, a chip and the like) or a processor to execute all or some steps of the methods in the above embodiments. The storage medium described above may be a medium capable of storing program codes, which includes USB, a mobile hard disc, read-only memory (ROM), random access memory (RAM), a magnetic disc, an optical disc or the like.

Those skilled in the art may understand that the above embodiments are specific embodiments for implementing the present disclosure. However, in actual application, the embodiments may be changed in forms and details without departing from the spirit and scope of the present disclosure.

What is claimed is:

1. A method for playing a video, comprising:
acquiring video clip information of a video to be played, wherein the video to be played includes a plurality of video clips;
determining a tree relationship of the video to be played and a first video clip list corresponding to the tree relationship according to the video clip information; and
playing the video to be played based on the tree relationship, the first video clip list and a video clip selected by a user.

2. The method for playing the video according to claim 1, wherein the tree relationship of the video to be played includes a plurality of nodes, each node corresponding to a video clip, the plurality of nodes including a current node and one or more child nodes of the current node, wherein playing the video to be played based on the tree relationship, the first video clip list and the video clip selected by the user comprises:
displaying an option corresponding to each of the one or more child nodes of the current node after playing of a video clip corresponding to the current node in the tree relationship is completed; and
acquiring, according to a target child node corresponding to an option selected by the user, a video clip corresponding to the target child node from the first video clip list, and playing the video clip corresponding to the target child node.

3. The method for playing the video according to claim 2, wherein the video clip corresponding to each of the one or more child nodes of the current node is acquired from the first video clip list and preloaded into a first play queue when playing the video clip corresponding to the current node in the tree relationship; and
acquiring, according to the target child node corresponding to the option selected by the user, the video clip corresponding to the target child node from the first video clip list, and playing the video clip corresponding to the target child node comprises:
acquiring, according to the target child node corresponding to the option selected by the user, the video clip corresponding to the target child node from the first play queue after preloaded, and playing the video clip corresponding to the target child node.

4. The method for playing the video according to claim 3, wherein after the playing of the video clip corresponding to the current node in the tree relationship is completed, the method further comprises:
determining whether a video clip corresponding to a node subordinating to the current node includes the video clip corresponding to the current node;
responsive to determining that the video clip corresponding to the node subordinating to the current node includes the video clip corresponding to the current node, retaining the video clip corresponding to the current node in the first play queue; and
responsive to determining that the video clip corresponding to the node subordinating to the current node does not include the video clip corresponding to the current node, deleting the video clip corresponding to the current node from the first play queue.

5. The method for playing the video according to claim 3, wherein acquiring the video clip corresponding to each of the one or more child nodes of the current node from the first video clip list, and preloading the video clip corresponding to each of the one or more child nodes of the current node into the first play queue comprises:
acquiring a video clip corresponding the child node that is not included in the first play queue; and
preloading the video clip corresponding to the child node that is not included in the first play queue based on the first video clip list.

6. The method for playing the video according to claim 3, wherein acquiring the video clip corresponding to each of the one or more child nodes of the current node from the first video clip list, and preloading the video clip into the first play queue comprises:
determining whether a sum of data amounts occupied by video clips, each of which corresponding to each of the one or more child nodes of the current node, reaches a first preset threshold; and
responsive to determining that the sum of the data amounts occupied by the video clips, each of which corresponding to each of the one or more child nodes of the current node, does not reach the first preset threshold, preloading the video clip corresponding to each of the one or more child nodes into the first play queue.

7. The method for playing the video according to claim 3, wherein acquiring the video clip corresponding to each of the one or more child nodes of the current node from the first video clip list and preloading the video clip into the first play queue comprises:
determining whether a data amount occupied by the video clip corresponding to each of the one or more child nodes of the current node reaches a second preset threshold; and
preloading the video clip of the child node which occupies the data amount not reaching the second preset threshold into the first play queue.

8. The method for playing the video according to claim 2, wherein the first video clip list includes a playing path of the video clip corresponding to each of nodes in the tree relationship; and acquiring, according to the target child node corresponding to the option selected by the user, the video clip corresponding to the target child node from the first video clip list, and playing the video clip corresponding to the target child node comprises:
acquiring, according to the target child node corresponding to the option selected by the user, the playing path of the video clip corresponding to the target child node from the first video clip list, and playing the video clip corresponding to the target child node.

9. The method for playing the video according to claim 1, wherein before determining the tree relationship of the video to be played and the first video clip list corresponding to the tree relationship according to the video clip information, the method further comprises:
determining whether a current play mode is an interactive preview play mode or a main-thread preview play mode;
responsive to determining that the current play mode is the interactive preview play mode, proceeding to the step of determining the tree relationship of the video to be played and the first video clip list corresponding to the tree relationship according to the video clip information; and
responsive to determining that the current play mode is the main-thread preview play mode, determining a main thread relationship of the video to be played and a second video clip list corresponding to the main thread relationship according to the video clip information, and playing the video to be played based on the main thread relationship and the second video clip list;
wherein the main thread relationship is a chain structure formed by a plurality of index objects, each index object corresponding to a video clip.

10. The method for playing the video according to claim 9, wherein playing the video to be played based on the main thread relationship and the second video clip list comprises:
acquiring a video clip corresponding to a next index object from the second video clip list after playing of a video clip corresponding to a current index object in the main thread relationship is completed, and playing the video clip corresponding to the next index object.

11. The method for playing the video according to claim 10, wherein the video clip corresponding to the next index object is acquired from the second video clip list and preloaded into a second play queue when playing the video clip corresponding to the current index object in the main thread relationship; and
acquiring the video clip corresponding to the next index object from the second video clip list, and playing the video clip corresponding to the next index object comprises:
acquiring the video clip corresponding to the next index object from the second play queue after preloaded, and playing the video clip corresponding to the next index object.

12. The method for playing the video according to claim 11, wherein after the playing of the video clip corresponding to the current index object in the main thread relationship is completed, the method further comprises:
determining whether a video clip corresponding to an index object following the current index object includes the video clip corresponding to the current index object;
responsive to determining that the video clip corresponding to the index object following the current index object includes the video clip corresponding to the current index object, retaining the video clip corresponding to the current index object in the second play queue; and
responsive to determining that the video clip corresponding to the index object following the current index object does not include the video clip corresponding to the current index object, deleting the video clip corresponding to the current index object from the second play queue.

13. The method for playing the video according to claim 11, wherein acquiring the video clip corresponding to the next index object from the second video clip list, and preloading the video clip corresponding to the next index object into the second play queue comprises:
determining whether the second play queue includes the video clip corresponding to the next index object; and
responsive to determining that the second play queue does not include the video clip corresponding to the next index object, preloading the video clip corresponding to the next index object into the second play queue based on the second video clip list.

14. The method for playing the video according to claim 11, wherein acquiring the video clip corresponding to the next index object from the second video clip list, and preloading the video clip corresponding to the next index object into the second play queue comprises:
determining whether a data amount occupied by the video clip corresponding to the next index object reaches a third preset threshold; and
responsive to determining that the data amount occupied by the video clip corresponding to the next index object does not reach the third preset threshold, preloading the video clip corresponding to the next index object into the second play queue.

15. The method for playing the video according to claim 1, wherein before acquiring the video clip information of the video to be played, the method further comprises:
acquiring path information of the video to be played, wherein the path information is local path information or network address information; and
acquiring the video clip information of the video to be played comprises:
acquiring the video clip information of the video to be played according to the path information.

16. The method for playing the video according to claim 2, wherein displaying the option corresponding to each of the one or more child nodes of the current node comprises:
displaying a question corresponding to the current node and the option corresponding to each of the one or more child nodes of the current node.

17. An electronic device, comprising: at least one processor; and a memory communicatively coupled to the at least one processor; wherein the memory stores an instruction executable by the at least one processor, and the instruction is executed by the at least one processor to cause the at least one processor to perform a method for playing a video; wherein the method comprises:
acquiring video clip information of a video to be played, wherein the video to be played includes a plurality of video clips;
determining a tree relationship of the video to be played and a first video clip list corresponding to the tree relationship according to the video clip information; and
playing the video to be played based on the tree relationship, the first video clip list and a video clip selected by a user.

18. The electronic device according to claim 17, wherein the tree relationship of the video to be played includes a plurality of nodes, each node corresponding to a video clip, the plurality of nodes including a current node and one or more child nodes of the current node, wherein playing the video to be played based on the tree relationship, the first video clip list and the video clip selected by the user comprises:
displaying an option corresponding to each of the one or more child nodes of the current node after playing of a video clip corresponding to the current node in the tree relationship is completed; and
acquiring, according to a target child node corresponding to an option selected by the user, a video clip corresponding to the target child node from the first video clip list, and playing the video clip corresponding to the target child node.

19. The electronic device according to claim 18, wherein the video clip corresponding to each of the one or more child nodes of the current node is acquired from the first video clip list and preloaded into a first play queue when playing the video clip corresponding to the current node in the tree relationship; and
acquiring, according to the target child node corresponding to the option selected by the user, the video clip corresponding to the target child node from the first video clip list, and playing the video clip corresponding to the target child node comprises:
acquiring, according to the target child node corresponding to the option selected by the user, the video clip corresponding to the target child node from the first play queue after preloaded, and playing the video clip corresponding to the target child node.

20. A non-transitory computer readable storage medium, comprising a computer readable instruction which, when read and executed by a computer, causes the computer to perform a method for playing a video; wherein the method comprises:
acquiring video clip information of a video to be played, wherein the video to be played includes a plurality of video clips;
determining a tree relationship of the video to be played and a first video clip list corresponding to the tree relationship according to the video clip information; and
playing the video to be played based on the tree relationship, the first video clip list and a video clip selected by a user.
